(19) United States
(12) Patent Application Publication
(10) Pub. No.: US 2025/0309804 A1
(43) Pub. Date: Oct. 2, 2025

(54) MOTOR CONTROLLER, MOTOR CONTROL PROGRAM, AND MOTOR SYSTEM

(71) Applicant: ROHM CO., LTD., Kyoto (JP)

(72) Inventors: Yuji KUNIDA, Kyoto (JP); Kenji ASAI, Kyoto (JP)

(21) Appl. No.: 19/092,956

(22) Filed: Mar. 27, 2025

(30) Foreign Application Priority Data
Mar. 28, 2024 (JP) 2024-054312

(51) Int. Cl. H02P 21/16

(52) U.S. Cl. CPC H02P 21/16; H02P 2207/05

(57) ABSTRACT

A motor controller includes a control circuit configured to perform vector control of a motor, and a driver configured to supply the motor with an applied voltage on the basis of an output from the control circuit. The control circuit compares the applied voltage with an induced voltage of the motor obtained by calculation, and if the induced voltage is higher than the applied voltage, the control circuit determines that the motor is in an out-of-step state.

### CROSS-REFERENCE TO RELATED APPLICATIONS

This nonprovisional application claims priority under 35 U.S.C. § 119(a) to Patent Application No. 2024-54312 filed in Japan on Mar. 28, 2024, the entire contents of which are hereby incorporated by reference.

### BACKGROUND OF THE INVENTION

### Field of the Invention

The invention disclosed in this specification relates to a motor controller, a motor control program, and a motor system.

### Description of Related Art

In a motor such as a permanent magnet synchronous motor, which does not have a commutation mechanism using brushes, it is necessary to switch directions of currents supplied to coils in accordance with a rotor position. As a driving method of the permanent magnet synchronous motor, there is known a method of using rotor position information obtained from a position sensor such as a Hall sensor.

Note that as an example of a conventional technique related to the above, there is Patent Document 1 (JP-A-2020-58119).

### BRIEF DESCRIPTION OF THE DRAWINGS

FIG. 1 is a schematic structural diagram of a motor system.

FIG. 2 is a timing chart illustrating an applied voltage and an induced voltage of a motor in a drive state.

FIG. 3 is a timing chart illustrating the applied voltage and the induced voltage when the motor has changed from a normal powering state to an out-of-step state.

FIG. 4 is a flowchart illustrating an out-of-step detection operation in the motor system.

FIG. 5 is a timing chart illustrating an operation of a motor controller according to a modified example.

FIG. 6 is a flowchart illustrating the out-of-step detection operation of the motor controller according to the modified example.

### DETAILED DESCRIPTION OF THE PREFERRED EMBODIMENTS

Hereinafter, an embodiment is described with reference to the drawings. Note that in this specification, “to connect” includes a case “to electrically connect”.

### Motor System 100

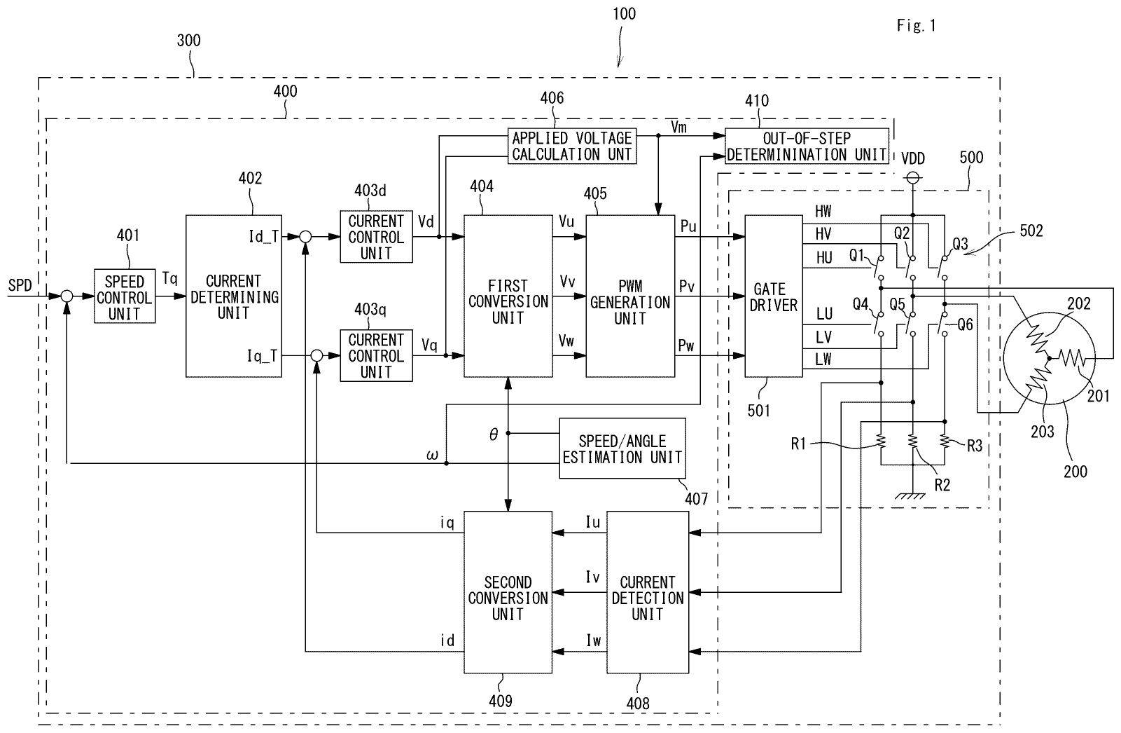

FIG. 1 is a schematic structural diagram of a motor system 100. The motor system 100 illustrated in FIG. 1 includes a motor 200 and a motor controller 300.

### Motor 200

The motor 200 is a permanent magnet synchronous motor. The motor 200 has a U-phase coil 201, a V-phase coil 202, and a W-phase coil 203. The U-phase coil 201, the V-phase coil 202, and the W-phase coil 203 are applied with appropriate voltages at appropriate timings so that currents flow, and hence the motor 200 rotates at a desired rotation speed. The motor 200 is a position sensor-less motor that does not have a position sensor such as a Hall sensor for detecting rotation speed and rotation angle of a rotor (not shown).

### Motor Controller 300

The motor controller 300 includes a control circuit 400 and a driver circuit 500. The motor controller 300 is supplied with a target speed SPD of the motor 200 from a not-shown external drive control unit. Note that the target speed SPD is information of the rotation speed when the motor 200 is driven. In addition, the target speed SPD may include information of start and stop of the motor 200. In other words, the motor controller 300 drives the motor 200 at the target speed SPD.

### Control Circuit 400

The control circuit 400 is a circuit for performing vector control of the motor 200. The control circuit 400 includes a speed control unit 401, a current determining unit 402, current control units 403d and 403q, a first conversion unit 404, a pulse width modulation (PWM) generation unit 405, an applied voltage calculation unit 406, a speed/angle estimation unit 407, a current detection unit 408, a second conversion unit 409, and an out-of-step determination unit 410.

The speed control unit 401 is supplied with a signal including information of the target speed SPD from the external drive control unit. The speed control unit 401 determines a target torque Tq of the motor 200 on the basis of the target speed SPD. The speed control unit 401 obtains information of a present rotation speed ω of the motor 200 from the speed/angle estimation unit 407, compares the same with the target speed SPD, and outputs information of the target torque Tq so that the motor 200 rotates at the target speed SPD, using a method such as a proportional integral (PI) control, for example.

Information of the target torque Tq is supplied to the current determining unit 402. The current determining unit 402 determines a target d-axis current Id_T and a target q-axis current Iq_T, which corresponds to a rotation coordinate system for driving the motor 200 at the target torque Tq. Further, the current determining unit 402 supplies information of the target d-axis current Id_T to the current control unit 403d, and it supplies information of the target q-axis current Iq_T to the current control unit 403q.

The current control unit 403d determines a d-axis voltage Vd to be supplied to the motor 200 on the basis of the target d-axis current Id_T. Further, the current control unit 403d supplies information of the d-axis voltage Vd to the first conversion unit 404. Similarly, the current control unit 403q determines a q-axis voltage Vq to be supplied to the motor 200 on the basis of the target q-axis current Iq_T. Then, the current control unit 403q supplies information of the q-axis voltage Vq to the first conversion unit 404. Note that the current control unit 403d and the current control unit 403q may be constituted of a single combined circuit.

The current control unit 403d obtains information of a d-axis current id that is a current flowing from the second conversion unit 409 to the motor 200. Further, the current control unit 403d compares the target d-axis current Id_T with the d-axis current id, adjusts the d-axis voltage Vd so that the currents are equal to each other, and supplies information of the d-axis voltage Vd to the first conversion unit 404. The current control unit 403d uses a method such as the PI control, for example.

Similarly, the current control unit 403q obtains information of a q-axis current iq that is a current flowing from the second conversion unit 409 to the motor 200. Further, the current control unit 403q compares the target q-axis current Iq_T with the q-axis current iq, adjusts the q-axis voltage Vq so that the currents are equal to each other, and supplies information of the q-axis voltage Vq to the first conversion unit 404. Similarly to the current control unit 403d, the current control unit 403q uses a method such as the PI control, for example.

The first conversion unit 404 converts the d-axis voltage Vd and the q-axis voltage Vq, which are two-phase voltages, into a U-phase voltage Vu, a V-phase voltage Vv, and a W-phase voltage Vw, which are three-phase voltages to be supplied to the motor 200, on the basis of the d-axis voltage Vd, the q-axis voltage Vq, and an angle θ of the motor 200 supplied from the speed/angle estimation unit 407.

The first conversion unit 404 converts the d-axis voltage Vd and the q-axis voltage Vq into two-axis fixed axis voltages using an inverse Park transformation. Further, the first conversion unit 404 performs an inverse Clark transformation on the basis of the two-axis fixed axis voltages, and determines the U-phase voltage Vu to be supplied to the U-phase coil 201, the V-phase voltage Vv to be supplied to the V-phase coil 202, and the W-phase voltage Vw to be supplied to the W-phase coil 203. Further, the first conversion unit 404 outputs information of the U-phase voltage Vu, information of the V-phase voltage Vv, and information of the W-phase voltage Vw to the PWM generation unit 405.

The applied voltage calculation unit 406 calculates an applied voltage Vm, using the d-axis voltage Vd output from the current control unit 403d and the q-axis voltage Vq output from the current control unit 403q. The d-axis voltage Vd and the q-axis voltage Vq are respectively a d-axis component (a magnetic field component voltage) and a q-axis component (a torque component voltage) of the applied voltage Vm. Therefore, the applied voltage calculation unit 406 calculates the applied voltage Vm from the d-axis voltage Vd and the q-axis voltage Vq. Note that the applied voltage Vm is obtained by combining the d-axis voltage Vd and the q-axis voltage Vq. Specifically, the applied voltage Vm is obtained as the square root of the sum of the square of the d-axis voltage Vd and the square of the q-axis voltage Vq, using the Pythagorean theorem. The applied voltage calculation unit 406 supplies information of the applied voltage Vm to the PWM generation unit 405. In addition, the applied voltage calculation unit 406 supplies information of the applied voltage Vm to the out-of-step determination unit 410.

The PWM generation unit 405 is supplied with information of the applied voltage Vm, the U-phase voltage Vu, the V-phase voltage Vv, and the W-phase voltage Vw. The PWM generation unit 405 generates a U-phase PWM pulse signal Pu corresponding to a duty factor of the voltage applied to the U-phase coil 201, a V-phase PWM pulse signal Pv corresponding to a duty factor of the voltage applied to the V-phase coil 202, and a W-phase PWM pulse signal Pw corresponding to a duty factor of the voltage applied to the W-phase coil 203, on the basis of the applied voltage Vm, the U-phase voltage Vu, the V-phase voltage Vv, and the W-phase voltage Vw. Further, the PWM generation unit 405 supplies the U-phase PWM pulse signal Pu, the V-phase PWM pulse signal Pv, and the W-phase PWM pulse signal Pw to the driver circuit 500.

The driver circuit 500 applies the U-phase voltage Vu, the V-phase voltage Vv, and the W-phase voltage Vw to the U-phase coil 201, the V-phase coil 202, and the W-phase coil 203 of the motor 200, respectively, on the basis of the U-phase PWM pulse signal Pu, the V-phase PWM pulse signal Pv, and the W-phase PWM pulse signal Pw. Note that details of the driver circuit 500 will be described later.

The current detection unit 408 obtains currents flowing in a three-phase full bridge circuit 502 described later of the driver circuit 500, and on the basis of the current, the current detection unit 408 detects current flowing in the U-phase coil 201, the V-phase coil 202, and the W-phase coil 203 of the motor 200. Further, the current detection unit 408 calculates a U-phase current Iu flowing in the U-phase coil 201, a V-phase current Iv flowing in the V-phase coil 202, and a W-phase current Iw flowing in the W-phase coil 203. Further, the current detection unit 408 supplies the U-phase current Iu, the V-phase current Iv, and the W-phase current Iw to the second conversion unit 409.

The second conversion unit 409 converts the U-phase current Iu, the V-phase current Iv, and the W-phase current Iw into the d-axis current id and the q-axis current iq, which are two-phase currents, on the basis of the U-phase current Iu, the V-phase current Iv, the W-phase current Iw, and the angle θ.

The second conversion unit 409 performs a Clarke transformation, so as to convert the U-phase current Iu, the V-phase current Iv, and the W-phase current Iw into two-axis fixed axis currents, i.e., currents of the α-axis and β-axis. Further, the second conversion unit 409 performs a Park transformation, so as to convert the two-axis fixed axis currents into the d-axis current id and the q-axis current iq, which are two-axis rotation axis currents. The d-axis current id and the q-axis current iq of the second conversion unit 409 are used as present current values of the current control unit 403d and the current control unit 403q, respectively.

The speed/angle estimation unit 407 detects the rotation speed ω and the angle θ of the motor 200, on the basis of the current flowing in the motor 200 and the applied voltage. The information of the rotation speed ω is used as present speed information of the speed control unit 401. In addition, the rotation speed ω is supplied to the out-of-step determination unit 410. The angle θ is supplied to the first conversion unit 404 and the second conversion unit 409. Note that the rotation speed ω and the angle θ are numeric values estimated by the speed/angle estimation unit 407, and they may be shifted from the real rotation speed and angle of the motor 200.

The out-of-step determination unit 410 determines an out-of-step state that is one of abnormal drive states of the motor 200. In the motor 200 that is being driven, an induced voltage is generated by an effect of coils and magnets of the motor 200. The induced voltage cannot be directly detected but is estimated from the rotation speed ω of the motor 200. Note that an induced voltage VB is calculated by the following equation.

VB=ke×ω(ke: back emf constant)

The back emf constant ke is a constant, and hence the induced voltage VB is proportional to the rotation speed ω. Therefore, the out-of-step determination unit 410 stores the back emf constant ke in advance, and estimates the induced voltage VB from the back emf constant ke and the rotation speed ω supplied from the speed/angle estimation unit 407. Note that it is configured that the induced voltage VB is calculated in the out-of-step determination unit 410, but it may be possible to configure to calculate the induced voltage VB in the speed/angle estimation unit 407. In this case, instead of the rotation speed ω, the induced voltage VB may be supplied from the speed/angle estimation unit 407 to the out-of-step determination unit 410. In addition, the rotation speed ω and the induced voltage VB may be supplied.

In addition, the out-of-step determination unit 410 is supplied with the applied voltage Vm from the applied voltage calculation unit 406. Further, the out-of-step determination unit 410 compares the induced voltage VB with the applied voltage Vm so as to detect whether or not the motor 200 is out of step. Details of the out-of-step of the motor 200 and a detection procedure of the out-of-step will be described later.

### Driver Circuit 500

The driver circuit 500 is a circuit that applies voltages to the U-phase coil 201, the V-phase coil 202, and the W-phase coil 203 of the motor 200. The driver circuit 500 includes a gate driver 501 and the three-phase full bridge circuit 502.

### Three-Phase Full Bridge Circuit 502

The three-phase full bridge circuit 502 is a circuit that applies voltages to the U-phase coil 201, the V-phase coil 202, and the W-phase coil 203 of the motor 200. The three-phase full bridge circuit 502 includes a U-phase leg, a V-phase leg, and a W-phase leg.

Each phase leg includes an upper arm and a lower arm. The upper arm and the lower arm respectively include switching elements Q1 to Q6 such as a bipolar transistor, a metal oxide semiconductor (MOS) field-effect transistor, or an insulated gate bipolar transistor (IGBT).

As illustrated in FIG. 1, the upper arm of the U-phase leg has the switching element Q1, and the lower arm of the same has the switching element Q4. In the U-phase leg, a first terminal of the upper arm is connected to a power supply terminal and is supplied with a power supply voltage VDD. A second terminal of the upper arm and a lower arm first terminal are connected in series to each other. It is configured that the second terminal of the lower arm is connected to a ground terminal via a shunt resistor R1.

The U-phase coil 201 is connected to a part at which the upper arm and the lower arm of the U-phase leg are connected to each other. The current detection unit 408 is connected to a part between the second terminal of the lower arm and the shunt resistor R1. In other words, the current detection unit 408 detects a voltage converted by the shunt resistor R1, so as to detect a current flowing in the U-phase leg.

The upper arm of the V-phase leg has the switching element Q2, and the lower arm of the same has the switching element Q5. In the V-phase leg, the first terminal of the upper arm is connected to the power supply terminal, and is supplied with the power supply voltage VDD. The second terminal of the upper arm and the lower arm first terminal are connected in series to each other. It is configured that the second terminal of the lower arm is connected to the ground terminal via a shunt resistor R2.

The V-phase coil 202 is connected to a part at which the upper arm and the lower arm of the V-phase leg are connected to each other. The current detection unit 408 is connected to a part between the second terminal of the lower arm and the shunt resistor R2. In other words, the current detection unit 408 detects a voltage converted by the shunt resistor R2, so as to detect a current flowing in the V-phase leg.

The upper arm of the W-phase leg has the switching element Q3, and the lower arm of the same has the switching element Q6. In the W-phase leg, the first terminal of the upper arm is connected to the power supply terminal, and is supplied with the power supply voltage VDD. The second terminal of the upper arm and the lower arm first terminal are connected in series to each other. It is configured that the second terminal of the lower arm is connected to the ground terminal via a shunt resistor R3.

The W-phase coil 203 is connected to a part at which the upper arm and the lower arm of the W-phase leg are connected to each other. The current detection unit 408 is connected to a part between the second terminal of the lower arm and the shunt resistor R3. In other words, the current detection unit 408 detects a voltage converted by the shunt resistor R3, so as to detect a current flowing in the W-phase leg.

### Gate Driver 501

The gate driver 501 is supplied with the U-phase PWM pulse signal Pu, the V-phase PWM pulse signal Pv, and the W-phase PWM pulse signal Pw from the PWM generation unit 405. On the basis of the U-phase PWM pulse signal Pu, the V-phase PWM pulse signal Pv, and the W-phase PWM pulse signal Pw, the gate driver 501 supplies drive signals to drive the switching elements Q1 to Q6, respectively.

The gate driver 501 generates a U-phase upper gate signal HU to drive the switching element Q1, and a U-phase lower gate signal LU supplied to the gate of the switching element Q4 to drive the switching element Q4, from the U-phase PWM pulse signal Pu.

The gate driver 501 generates a V-phase upper gate signal HV to drive the switching element Q2, and a V-phase lower gate signal LV supplied to the gate of the switching element Q5 to drive the switching element Q5, from the V-phase PWM pulse signal Pv.

The gate driver 501 generates a W-phase upper gate signal HW to drive the switching element Q3, and a W-phase lower gate signal LW supplied to the gate of the switching element Q6 to drive the switching element Q6, from the W-phase PWM pulse signal Pw.

Note that the current detection unit 408 detects currents flowing in the U-phase leg, the V-phase leg, and the W-phase leg. On the basis of the currents, the current detection unit 40 obtains currents flowing in the U-phase coil 201, the V-phase coil 202, and the W-phase coil 203. Note that in the driver circuit 500 of this embodiment, it is configured that the shunt resistors R1, R2, and R3 are respectively disposed between the ground terminal and the second terminals of the lower arms of the phase legs of the three-phase full bridge circuit 503, but this is not a limitation. It may be possible to configure to insert a single shunt resistor by connecting all the second terminals of the lower arms, or to insert the shunt resistors only in two phases out of the U-phase, the V-phase, and the W-phase, so as to detect the currents of the two phases only. Also in these configurations, the current detection unit 408 can obtain the current flowing in each phase coil.

In addition, in the motor controller 300 of this embodiment, the PWM generation unit 405 outputs the PWM pulse signals Pu, Pv, and Pw, but this is not a limitation. For instance, it may be possible to supply signals to drive the switching elements Q1 to Q6 (signals corresponding to the gate signals). In this configuration, the gate driver 501 may be configured to amplify the supplied signals, which are supplied to the switching elements Q1 to Q6.

The motor controller 300 described above may be configured to be all housed in a single package, or may be configured to be partially housed in a single package. For instance, it may be possible to configure to house the control circuit 400 and the gate driver 501 in a package, and to dispose the three-phase full bridge circuit 502 outside the package.

In addition, processing units 401 to 410 of the control circuit 400 may be each constituted of a single processing circuit, or some of the processing units may be combined in a processing circuit. Further, all the processing units may be combined in a processing circuit. In addition, the gate driver 501 may also be included in the processing circuit. Further, the package may include an arithmetic circuit, and at least a part of the processing units 401 to 410 may be provided as a program that can be executed by the arithmetic circuit. Note that as a method of providing the program, there is an example in which the program is provided in a state of being recorded on a recording medium such as a memory or a disc. In addition, the program may be supplied via the Internet.

### Out-of-Step of Motor 200

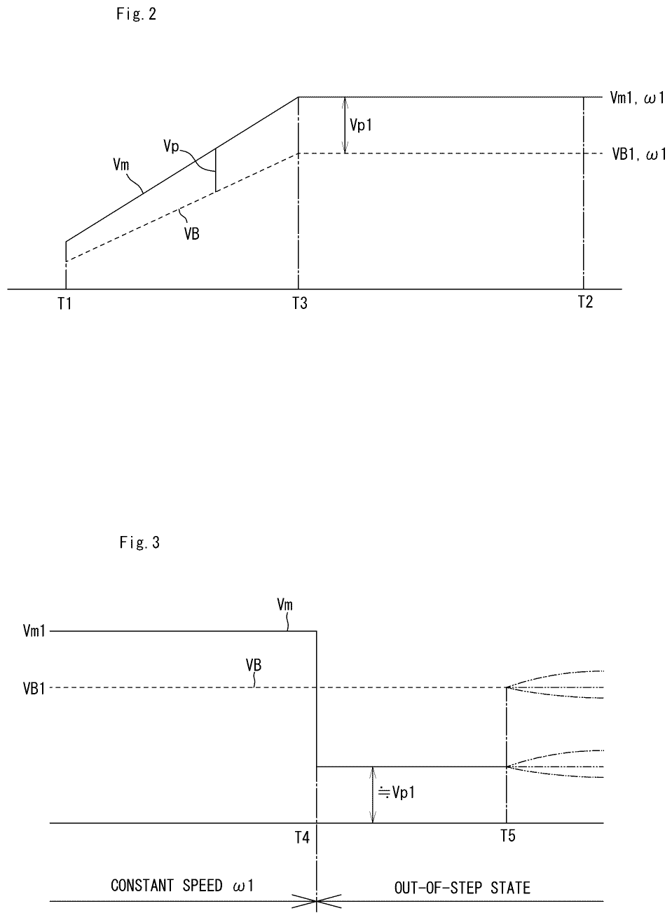

The out-of-step of the motor 200 is described below. FIG. 2 is a timing chart illustrating the applied voltage Vm and the induced voltage VB in the drive state of the motor 200. In the timing chart illustrated in FIG. 2, the horizontal axis represents time point, and the vertical axis represents voltage.

In the drive state illustrated in FIG. 2, after time point T1, the motor 200 is driven by the vector control. In addition, between time points T1 and T2, the motor 200 is supposed to be driven in a normal powering state (a state in which the out-of-step is not generated). When the motor 200 is rotating at low speed, and when synchronized start is used, for example, synchronized operation is performed until time point T1. The motor controller 300 detects that the out-of-step is generated in the state where the motor 200 is driven by the vector control.

The motor controller 300 determines the d-axis voltage Vd and the q-axis voltage Vq to be supplied to the motor 200, on the basis of the target speed SPD, and on the basis of this voltage, appropriate voltages are supplied to the U-phase coil 201, the V-phase coil 202, and the W-phase coil 203. Further, the induced voltage VB is generated in the motor 200 along with the drive. As illustrated in FIG. 2, during time points T1 and T2, the motor 200 is driven in the normal powering state.

When the motor 200 is applied with the applied voltage Vm, and when the induced voltage VB is generated in the motor 200, the motor 200 is supplied substantially with a difference voltage between the applied voltage Vm and the induced voltage VB. Here, the voltage supplied to the motor 200 is referred to as a difference voltage Vp. In the section between time points T1 and T2, the motor 200 is in a steady operation. In other words, during time points T1 and T2, the U-phase coil 201, the V-phase coil 202, and the W-phase coil 203 of the motor 200 are each in the state where the induced voltage VB is generated. For this reason, in the normal powering state, the applied voltage Vm higher than the induced voltage VB is applied, and currents flow in the powering sides of the U-phase coil 201, the V-phase coil 202, and the W-phase coil 203 of the motor 200.

As illustrated in FIG. 2, when the motor 200 is accelerated, the induced voltage VB is increased along with an increase in the rotation speed w. Further, because the motor 200 is accelerated, the applied voltage Vm is also increased along with an increase in the rotation speed ω. Further, when the rotation speed ω of the motor 200 is stabilized at a constant speed (referred to as a constant speed ω1) at time point T3, the difference voltage Vp becomes a voltage necessary for rotating the motor 200 at a constant speed. When the motor 200 is driven at the constant speed ω1, the applied voltage Vm is referred to as a steady applied voltage Vm1, the induced voltage VB is referred to as a steady induced voltage VB1, and a difference between the steady applied voltage Vm1 and the steady induced voltage VB1 is referred to as a steady difference voltage Vp1.

Next, the applied voltage Vm and the induced voltage VB when an out-of-step stop as one of the out-of-step states is generated are described with reference to the drawings. Note that the out-of-step stop means a forced stop of a motor shaft of the motor 200 due to a mechanical factor other than the motor system, in a state where the motor controller 300 is driving the motor 200 by the vector control. FIG. 3 is a timing chart illustrating the applied voltage Vm and the induced voltage VB when the motor 200 is changed from the normal powering state to the out-of-step state. In the timing chart illustrated in FIG. 3, the horizontal axis represents time point, while the vertical axis represents voltage, similarly to FIG. 2. In FIG. 3, it is supposed that the motor 200 plunges into the out-of-step state at time point T4 from the state of being driven at the constant speed ω1 as illustrated in FIG. 2.

When the rotor of the motor 200 is forcedly stopped, the induced voltages that are actually generated (referred to as actually induced voltages) in the U-phase coil 201, the V-phase coil 202, and the W-phase coil 203 of the motor 200 become 0 V. For this reason, the difference voltage Vp that is supplied from the three-phase full bridge circuit 502 to the U-phase coil 201, the V-phase coil 202, and the W-phase coil 203 of the motor 200 becomes the same as the applied voltage Vm. In other words, when the motor 200 is forcedly stopped at time point T4, the difference voltage Vp supplied to the U-phase coil 201, the V-phase coil 202, and the W-phase coil 203 of the motor 200 becomes approximately equal to the steady applied voltage Vm1, and as a result of the rapid increase from the steady operation, the current flowing in each phase coil is also rapidly increased.

As a result, the current detection unit 408 detects the U-phase current Iu, the V-phase current Iv, and the W-phase current Iw, which are much larger than those when the motor 200 is driven at the constant speed ω1. For this reason, the current control unit 403d and the current control unit 403q are supplied with information of the d-axis current id and the q-axis current iq, which are larger than those when the motor 200 is driven at the constant speed ω1. The current control unit 403d and the current control unit 403q are controlled on the basis of the d-axis current id and the q-axis current iq, in the direction of decreasing the d-axis voltage Vd and the q-axis voltage Vq, and hence the applied voltage Vm is decreased.

The period from time point T4 to time point T5 just after that, the state is a state just after the out-of-step stop, and the actually induced voltage is 0 V during this period. Therefore, corresponding to a change in the actually induced voltage, the motor controller 300 changes the applied voltage Vm from the steady applied voltage Vm1 to approximately the steady difference voltage Vp1. Note that the applied voltage Vm after time point T5 is determined depending on the state at that time. For this reason, in FIG. 3, the applied voltage Vm after time point T5 is shown by a two-dot dashed line, so as to indicate being unsteady.

A described above, the speed/angle estimation unit 407 estimates the rotation speed ω on the basis of the drive current, the drive voltage, and the like. Further, in the motor controller 300, the process of calculating the rotation speed ω is performed later than the process of changing the applied voltage Vm.

The process of estimating the rotation speed ω is performed at time point T5 after time point T4. In other words, during time points T4 and T5, the speed/angle estimation unit 407 continues the state where the rotation speed ω of the motor 200 is estimated as the constant speed ω1, and the out-of-step determination unit 410 is supplied with the constant speed ω1. The out-of-step determination unit 410 calculates the induced voltage VB (the steady induced voltage VB1) on the basis of the constant speed ω1 and the back emf constant ke.

As illustrated in FIG. 3, in the out-of-step determination unit 410, the induced voltage VB is higher than the applied voltage Vm at least during time points T4 and T5. If the induced voltage VB is higher than the applied voltage Vm, the out-of-step determination unit 410 can determine that the motor 200 is in the out-of-step state, i.e., the state where a drive abnormality is generated. The motor controller 300 utilizes this so as to detect the out-of-step of the motor 200. Note that the induced voltage VB after time point T5 is also changed depending on the state at that time. For this reason, in FIG. 3, the induced voltage VB after time point T5 is shown by a two-dot dashed line, so as to indicate being unsteady.

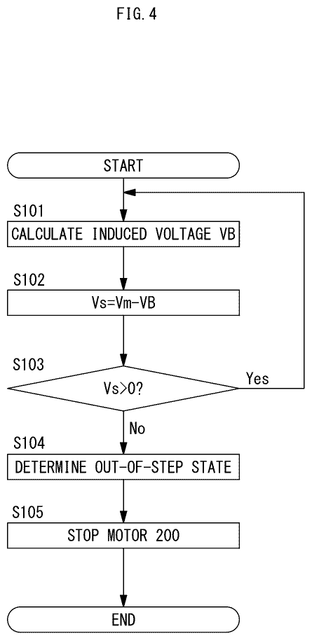

Next, the out-of-step detection operation in the motor system 100 is described with reference to the drawings. FIG. 4 is a flowchart illustrating the out-of-step detection operation in the motor system 100.

If the motor system 100 uses a synchronized start method, when the rotation speed ω of the motor 200 is low, the motor controller 300 drives the motor 200 using not the vector control but the synchronized operation control. The out-of-step determination unit 410 of the motor controller 300 detects the out-of-step of the motor 200, using the applied voltage Vm and the induced voltage VB as parameters used for the vector control.

The out-of-step detection operation illustrated in FIG. 4 is an operation when the motor controller 300 is driving the motor 200 by the vector control. When the motor 200 is being driven, the speed/angle estimation unit 407 is estimating the rotation speed ω of the motor 200. The out-of-step determination unit 410 calculates the induced voltage VB, on the basis of the rotation speed ω supplied from the speed/angle estimation unit 407 (Step S101). Note that the speed/angle estimation unit 407 may hold the estimated rotation speed ω, so as to regularly supply the rotation speed œ that is previously estimated to the out-of-step determination unit 410, or may supply to the out-of-step determination unit 410 just after estimation.

Note that it may be possible that the speed/angle estimation unit 407 estimates the induced voltage VB on the basis of the rotation speed ω, and supplies information of the induced voltage VB to the out-of-step determination unit 410. In this case too, the speed/angle estimation unit 407 may calculate the induced voltage VB just after estimating the rotation speed ω, or may regularly calculate the induced voltage VB on the basis of the rotation speed ω that is previously estimated.

The out-of-step determination unit 410 calculates a difference value Vs by subtracting the induced voltage VB from the applied voltage Vm (Step S102). Note that the applied voltage Vm is always calculated when the motor 200 is driven. Further, the out-of-step determination unit 410 checks whether or not the difference value Vs is larger than “0” (Step S103). If the difference value Vs is larger than “0” (Yes in Step S103), the process returns to Step S101, so as to repeat the process.

If the difference value Vs is smaller than “0” (No in Step S103), the out-of-step determination unit 410 determines that the motor 200 is in the out-of-step state (Step S104). Then, the motor controller 300 stops the motor 200 (Step S105).

As described above, the motor controller 300 compares the applied voltage Vm and the induced voltage VB that are parameters necessary for driving the motor 200 by the vector control, so as to detect the out-of-step of the motor 200. For this reason, in the motor controller 300, the out-of-step can be detected without adding another component such as a sensor to the conventional configuration. In addition, the motor control program has a structure in which simple codes for comparing the applied voltage Vm and the induced voltage VB are added to an existing control program, and hence the function of detecting the out-of-step can be easily added to an existing motor controller 300.

Further, the motor controller 300 and the motor control program have the structure in which the out-of-step is detected from a result of comparison between the applied voltage Vm and the induced voltage VB, which are required when the vector control is performed, and hence the out-of-step can be detected even in a state where the three-phase full bridge circuit 502 is performing output to the motor 200. In other words, using the motor controller 300 of this embodiment, it is not necessary to temporarily turn off an inverter output like a conventional method, in which the out-of-step is determined by monitoring the induced voltage.

### Modified Example

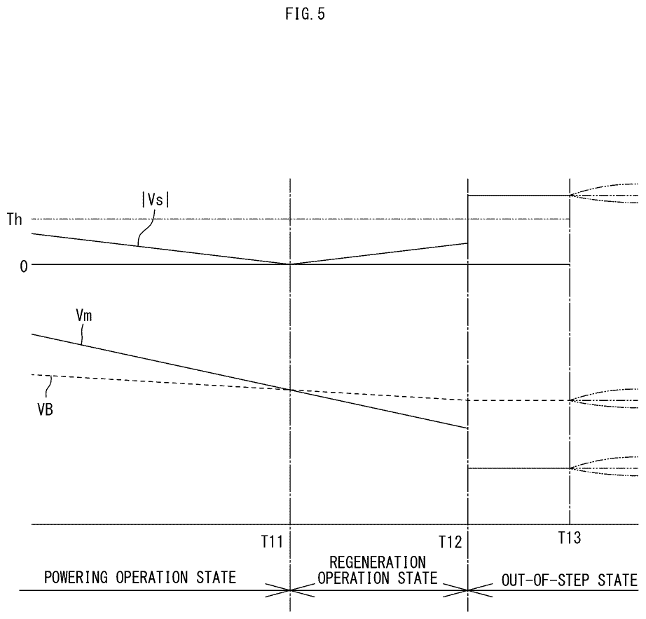

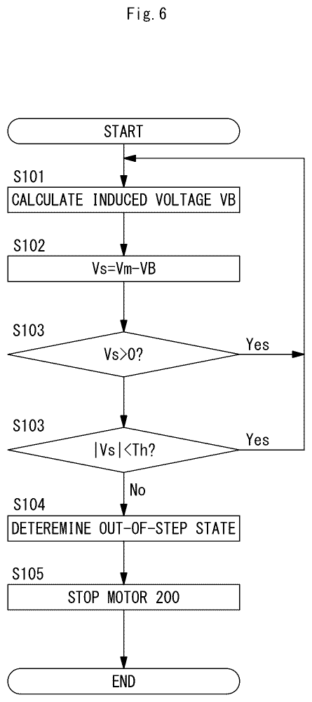

FIG. 5 is a timing chart illustrating an operation of the motor controller 300 of a modified example. FIG. 6 is a flowchart illustrating the out-of-step detection operation of the motor controller 300 of the modified example. The motor system 100 of the modified example has the same structure as the motor system 100 described above, except for the out-of-step detection operation. For this reason, in the motor system 100 of the modified example, the same part as that of the above structure is denoted by the same numeral or symbol, and overlapping detailed description of the same part is omitted. The timing chart illustrated in FIG. 5 shows variations of the applied voltage Vm and the induced voltage VB along with time elapse, and shows variation of the absolute value of the difference value Vs between the applied voltage Vm and the induced voltage VB along with time elapse.

The motor system 100 may have a regeneration operation mode in which the induced voltage VB of the motor 200 is utilized. In the motor system 100, the motor 200 may rotate at a speed faster than the target speed SPD due to an inertial force of an object that is driven by the motor 200. In this case, currents flow in the U-phase coil 201, the V-phase coil 202, and the W-phase coil 203 of the motor 200, in the directions opposite to those in the powering operation. For this reason, in the regeneration operation mode, the applied voltage Vm is lower than the induced voltage VB.

In the operation illustrated in FIG. 5, the motor 200 changes from the powering operation state to the regeneration operation state at time point T11. In the motor system 100, when the applied voltage Vm decreases gradually, the difference between the applied voltage Vm and the induced voltage VB is decreased. Then, a high and low relationship between the applied voltage Vm and the induced voltage VB is reversed at time point T11. After time point T11, the applied voltage Vm is lower than the induced voltage VB, but the motor 200 is in the regeneration operation and is not in the out-of-step state.

In other words, in the motor system 100, the induced voltage VB calculated from the rotation speed ω estimated by the motor controller 300 is higher than the applied voltage Vm in either the case where the motor 200 is in the regeneration operation, or the case where the motor 200 is in the out-of-step state.

When the induced voltage VB is higher than the applied voltage Vm, the motor controller 300 detects the out-of-step of the motor 200 operating in the regeneration operation mode, on the basis of the absolute value of the difference value Vs between the induced voltage VB and the applied voltage Vm. For instance, in the operation illustrated in FIG. 5, it is supposed that the motor 200 that was operating in the regeneration operation mode plunges into the out-of-step state at time point T12. The motor controller 300 detects that the absolute value of the difference value Vs is larger than a threshold value Th at least between time points T12 and T13. The motor controller 300 having the regeneration operation mode utilizes this, so as to detect the out-of-step in the regeneration operation.

Here, the out-of-step detection operation in the motor controller 300 having the regeneration operation mode is described. The flowchart illustrated in FIG. 6 is different from the flowchart illustrated in FIG. 4 in that Step S1031 is provided between Step S103 and Step S104. In the flowchart illustrated in FIG. 6, substantially the same part as in the flowchart illustrated in FIG. 4 is denoted by the same numeral or symbol, and overlapping detailed description is omitted.

The out-of-step determination unit 410 checks whether or not the difference value Vs is larger than “0” (Step S103). If the difference value Vs is larger than “0” (Yes in Step S103), the process returns to Step S101, so as to repeat the process.

If the difference value Vs is smaller than “0” (No in Step S103), the out-of-step determination unit 410 determines whether or not the absolute value of the difference value Vs is smaller than the threshold value Th (Step S1031). If the absolute value of the difference value Vs is smaller than the threshold value Th (Yes in Step S1031), the motor 200 is in the regeneration state, and the process returns to Step S101, so as to repeat the process.

If the absolute value of the difference value Vs is larger than the threshold value Th (No in Step S1031), the out-of-step determination unit 410 determines that the motor 200 is in the out-of-step state (Step S104). Then, the motor controller 300 stops the motor 200 (Step S105).

As described above, the motor controller 300 allows the motor 200 to perform the regeneration operation in the regeneration operation mode, while can accurately detect the out-of-step as the abnormal drive state. For instance, the difference value Vs between the applied voltage Vm and the induced voltage VB is larger in the case where the motor 200 rapidly decreases the speed, than in the case where the speed is gently decreased. Considering this, the motor controller 300 may be able to change the threshold value Th. In this way, if the threshold value Th can be changed, the motor system 100 can be used both in the case where the motor 200 rapidly decreases the speed, and in the case where the speed is gently decreased.

### Others

The embodiment of the present disclosure can be appropriately and variously modified in the scope of the technical concept recited in the claims. The various embodiments described above can be appropriately combined within the scope without contradiction. The above embodiment is merely an example of the embodiment of the present disclosure, and meaning of the present disclosure or a term of a structural element is not limited to that described in the above embodiment.

### Additional Remarks

In the following description, various embodiments described above are described as a whole.

As described above, a motor controller (300) may have a structure (first structure) including:
a control circuit (400) configured to perform vector control of a motor (200); and
a driver circuit (500) configured to supply the motor (200) with an applied voltage (Vm) on the basis of an output from the control circuit (400), in which
the control circuit (400) compares the applied voltage (Vm) with an induced voltage (VB) of the motor (200) obtained by calculation, and if the induced voltage (VB) is higher than the applied voltage (Vm), the control circuit (400) determines that the motor (200) is in an out-of-step state.

The motor controller (300) having the above first structure may have a structure (second structure), in which if the induced voltage (VB) is higher than the applied voltage (Vm), and if a difference (Vs) between the induced voltage (VB) and the applied voltage (Vm) is larger than a threshold value (Th), the control circuit (400) determines that the motor (200) is in the out-of-step state.

As described above, a motor system (100) may have a structure (third structure) including the motor controller (300) having the above first or second structure, and the motor (200).

As described above, a motor control program may have a structure (fourth structure) for comparing an applied voltage (Vm) with an induced voltage (VB) of the motor (200) obtained by calculation, so as to determine that the motor (200) is in an out-of-step state if the induced voltage (VB) is larger than the applied voltage (Vm).

The motor control program having the above fourth structure may have a structure (fifth structure) configured to determine that the motor (200) is in the out-of-step state if the induced voltage (VB) is larger than the applied voltage (Vm), and if a difference (Vs) between the induced voltage (VB) and the applied voltage (Vm) is larger than a threshold value (Th).

What is claimed is:

1. A motor controller comprising:
a control circuit configured to perform vector control of a motor; and
a driver circuit configured to supply the motor with an applied voltage on the basis of an output from the control circuit, wherein
the control circuit compares the applied voltage with an induced voltage of the motor obtained by calculation, and if the induced voltage is higher than the applied voltage, the control circuit determines that the motor is in an out-of-step state.

2. The motor controller according to claim 1, wherein if the induced voltage is higher than the applied voltage, and if a difference between the induced voltage and the applied voltage is larger than a threshold value, the control circuit determines that the motor is in the out-of-step state.

3. A motor system comprising:
the motor controller according to claim 1; and
a motor.

4. A motor control program for performing vector control of a motor, the program being configured to compare an applied voltage with an induced voltage of the motor obtained by calculation, and to determine that the motor is in an out-of-step state if the induced voltage is larger than the applied voltage.

5. The motor control program according to claim 4, configured to determine that the motor is in the out-of-step state if the induced voltage is larger than the applied voltage, and if a difference between the induced voltage and the applied voltage is larger than a threshold value.
